(19) United States
(12) Patent Application Publication
(10) Pub. No.: US 2018/0149622 A1
(43) Pub. Date: May 31, 2018

(54) METHOD AND APPARATUS FOR VIBROACOUSTIC MODULATION CRACK DETECTION AND CHARACTERIZATION OF CONDUITS AND OTHER STRUCTURES

(71) Applicant: Microline Technology Corporation, Traverse City, MI (US)

(72) Inventors: Dean M. Vieau, Traverse City, MI (US); Bruce I. Girrell, Traverse City, MI (US); Johana M. Chirinos, Traverse City, MI (US); Douglas W. Spencer, Rapid City, MI (US)

(21) Appl. No.: 15/825,312

(22) Filed: Nov. 29, 2017

Related U.S. Application Data
(60) Provisional application No. 62/427,508, filed on Nov. 29, 2016.

(51) Int. Cl. G01N 29/14; G01N 29/04; G01N 29/48; G01N 29/22

(52) U.S. Cl. CPC G01N 29/14; G01N 29/22; G01N 29/48; G01N 29/041

(57) ABSTRACT

A crack detecting system operable to detect cracks along a conduit or structure includes a tool movable along a conduit or structure and having at least one sensing device for sensing cracks in a wall of the conduit or structure. A processor is operable to process an output of the at least one sensing device. Responsive to processing of the output by the processor, the processor is operable to determine the presence of cracks at the wall of the conduit or structure. The at least one sensing device includes or provides a vibroacoustic modulation technique.

### CROSS REFERENCE TO RELATED APPLICATION

The present application claims the filing benefits of U.S. provisional application Ser. No. 62/427,508, filed Nov. 29, 2016, which is hereby incorporated herein by reference in its entirety.

### FIELD OF THE INVENTION

The present invention relates generally to a method of detecting cracks in a pipeline or conduit or tubular via a tool or device that is moved along and within the pipeline or conduit or tubular (or moved along an exterior surface of a conduit or tubular or plate or beam or other structure).

### BACKGROUND OF THE INVENTION

It is known to use a sensing device to sense or determine the strength of and/or freepoints and/or stresses and/or characteristics of flaws or defects in pipes and other tubulars. Examples of such devices are described in U.S. Pat. Nos. 4,708,204; 4,766,764; 8,035,374 and/or 8,797,033.

### SUMMARY OF THE INVENTION

The present invention provides a crack detecting system that is operable to detect cracks along a conduit. The crack detecting system comprises a tool that is movable along a conduit and that has at least one sensing device for sensing cracks in a wall of the conduit. The sensing device may comprise a wave generating device and a wave detecting or sensing device. A processor (at the tool or remote therefrom) is operable to process an output of the at least one sensing device. Responsive to processing of the output by the processor, the processor is operable to determine the presence of cracks at the wall of the conduit. The at least one sensing device comprises a vibroacoustic modulation (VAM) technique, such as one or more of the techniques discussed below, including, for example, (i) a pump and probe method, (ii) a passive listening method, (iii) a wall excitation method, (iv) a varying amplitude detection method, (v) a phase inversion method, (vi) a chaotic cavity method, (vii) an impedance method, (viii) a hoop stress detection method, (ix) a vibrothermography detection method, (x) an intermodulation detection method, (xi) a frequency shift detection method, (xii) an anti-resonance method, (xiii) a coda wave detection method, (xiv) a Lamb wave detection method, (xv) a ring-down attenuation method, and (xvi) a quality factor detection method.

These and other objects, advantages, purposes and features of the present invention will become apparent upon review of the following specification in conjunction with the drawings.

### BRIEF DESCRIPTION OF THE DRAWINGS

FIG. 1 shows a horizontal cross section of a pipe or tubular with a tool of the present invention disposed therein;

FIG. 2 shows a horizontal cross section of a pipe or tubular with another tool of the present invention disposed therein;

FIG. 3 shows a horizontal cross section of a pipe or tubular with another tool of the present invention disposed therein;

FIG. 4 is a table of various apparatus/systems/configurations/techniques of the present invention, showing different detection methods that are used for the different apparatus/systems/configurations/techniques;

FIG. 5 is a block diagram showing post-run data processing stages of the system of the present invention;

FIG. 6 is another block diagram showing real-time data processing in accordance with the present invention;

FIG. 7 is a schematic showing examples of Lamb waves;

FIG. 8 is a schematic showing an apparatus or system for crack detection in accordance with the present invention;

FIG. 9 is a schematic showing another apparatus or system for crack detection in accordance with the present invention;

FIG. 10 is a schematic showing a passive listening apparatus or system for crack detection in accordance with the present invention;

FIG. 11 is a schematic showing pipe wall surface or thickness excitation for an apparatus or system for crack detection in accordance with the present invention;

FIG. 12 is a schematic showing a varied amplitude apparatus or system for crack detection in accordance with the present invention;

FIG. 13 is a schematic showing a phase inversion apparatus or system for crack detection in accordance with the present invention;

FIG. 14 is a schematic showing a chaotic cavity apparatus or system for crack detection in accordance with the present invention;

FIGS. 15A-15B are schematics showing an impedance apparatus or system for crack detection in accordance with the present invention;

FIGS. 16A-16D are schematics showing another apparatus or system for crack detection in accordance with the present invention;

FIG. 17 is a schematic showing a vibrothermography apparatus or system for crack detection in accordance with the present invention;

FIG. 18 is a schematic showing inputs and outputs for a passive listening apparatus or system for crack detection in accordance with the present invention;

FIG. 19 is a schematic showing a graph of signals acquired via another apparatus or system for crack detection in accordance with the present invention;

FIG. 20 is a schematic showing frequency shifts as a function of amplitude for an apparatus or system for crack detection in accordance with the present invention;

FIG. 21 is a schematic showing an anti-resonance method for crack detection in accordance with the present invention;

FIGS. 22A-22B are schematics showing graphs of coda waves for a method for crack detection in accordance with the present invention;

FIG. 23 is a schematic showing ring down/attenuation for a method for crack detection in accordance with the present invention;

FIGS. 24A-24B are schematics showing Q-cues/factors for a method for crack detection in accordance with the present invention;

FIGS. 25A-25B are schematics showing phase inversion for a method for crack detection in accordance with the present invention; and

FIG. 26 is a thermal image showing a crack for a method for crack detection in accordance with the present invention.

### DESCRIPTION OF THE PREFERRED EMBODIMENTS

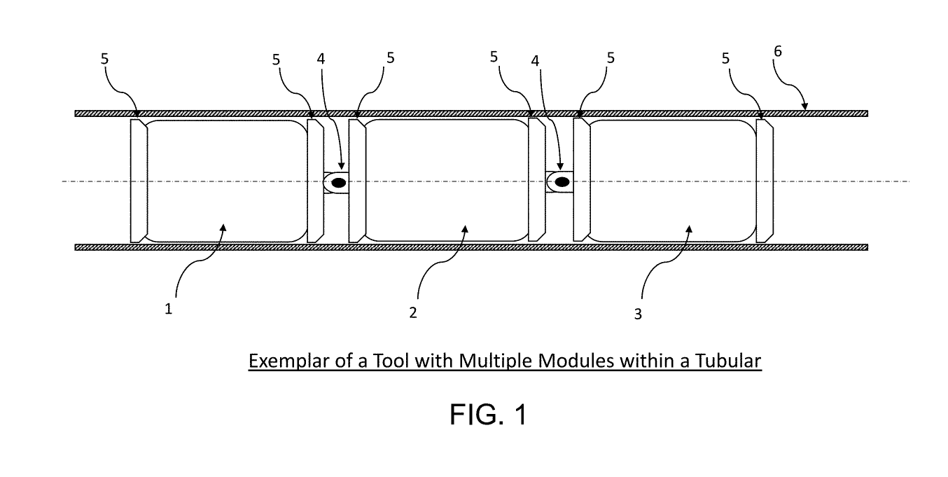

The present invention provides a system and method and apparatus for determining cracks in pipelines or well casings, and other tubulars or conduits. The tool (see, for example, FIGS. 1-4) can be operated in pipelines (e.g., inline inspection), downhole applications (drill strings, well casing and tubing), and other tubulars for the purpose of stress determination in the conduit walls (such as steel or type/grade of steel or the like), or the tool may be moved along any accessible surface of a conduit or tubular or plate or beam or other structure (such as, for example, an interior surface of a conduit or tubular or an exterior surface of a conduit or tubular or plate or beam).

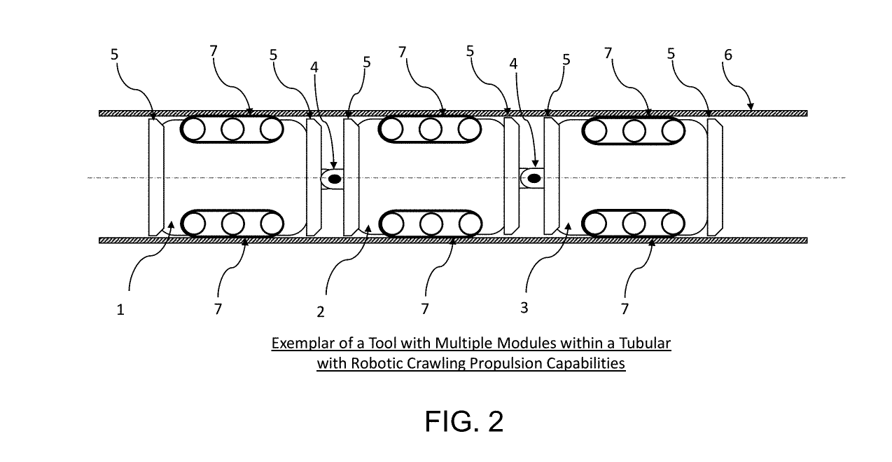

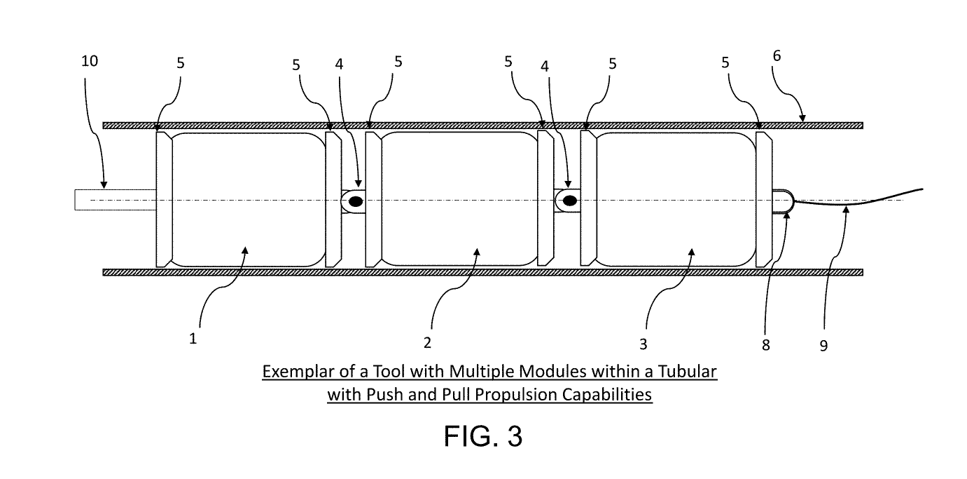

An example of a tool suitable for such crack detection is shown in FIG. 1. The tool comprises a plurality of modules 1, 2, 3 coupled together by respective universal joints, with each module having a drive cup and/or cleaning ring 5. The tool is moved along the tubular 6, whereby sensing devices of the modules operate to sense the presence of cracks at the tubular, as discussed below. Optionally, and such as shown in FIG. 2, the modules 1, 2, 3 of a tool may have a tracked drive 7 that operates to move the tool and modules along the tubular 6. Optionally, and such as shown in FIG. 3, the forwardmost module 3 of the tool may include a pull loop 8 that attaches to a pull cable 9, and/or the rearwardmost module 1 of the tool may have a coiled tube or pushing device 10, that function to move the tool and modules along the tubular 6.

The system of the present invention comprises a variety of Vibroacoustic Modulation (VAM) techniques and associated apparatus used in conjunction with associated detection methods in the pursuit of discovery and characterization of cracks and crack-like features. These cracks include, but are not limited to, stress corrosion cracking, fatigue cracks, cracks within welds, discontinuities, and/or the like. These cracks, when exposed to acoustic energy, may respond with motion, such as by opening and closing (Mode I crack behavior), by motion in in-plane sliding shear (Mode II crack behavior), and/or by motion in out-of-plane scissoring shear (Mode III crack behavior). The various techniques, or methods, may be employed individually, or in any combination of what can be termed “multi-sensor fusion”.

This synthesis of various techniques provides a highly redundant and stable platform for detection and characterization of cracks and crack-like flaws that may be encountered in pipelines, downhole applications, and other infrastructure entities. Using aspects of the systems/techniques of the present invention, cracks may be detected and characterized in various materials that are ferromagnetic and non-ferromagnetic, as well as metallic and non-metallic.

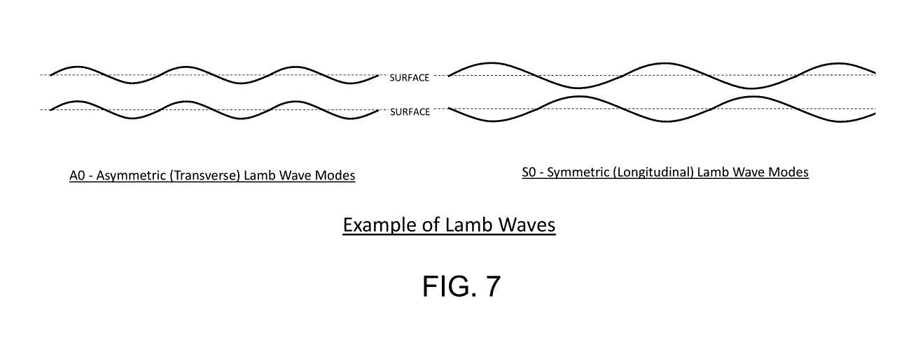

From the various techniques imparting energy to the material under test, various acoustic waves can be generated, such as, for example, compressional waves and Lamb waves. Lamb waves are generated within “thin” walls/materials via the various configurations and techniques discussed below. Lamb waves (see FIG. 7) are acoustic waves that can exist in relatively thin materials or elements, such as plates and tubulars, involving the symmetric or antisymmetric motion of both exterior surfaces of the material.

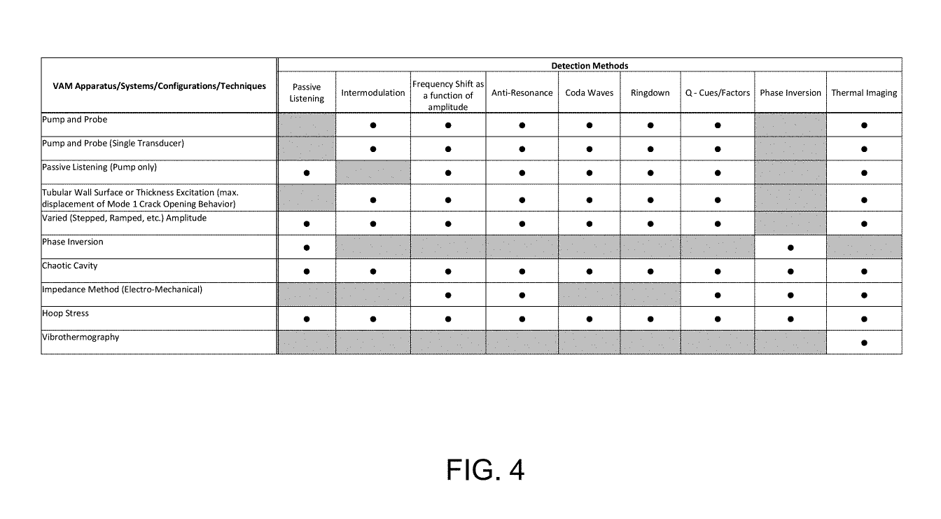

The various vibroacoustic modulation apparatus, systems, configurations and/or techniques, as well as associated detection methods along with their advantages are detailed below. For ease of reference, a matrix (FIG. 4) has been generated showing which detection methods correspond to which VAM apparatus, systems, configurations and/or techniques, as many of the apparatus configuration variations can use different detection methods.

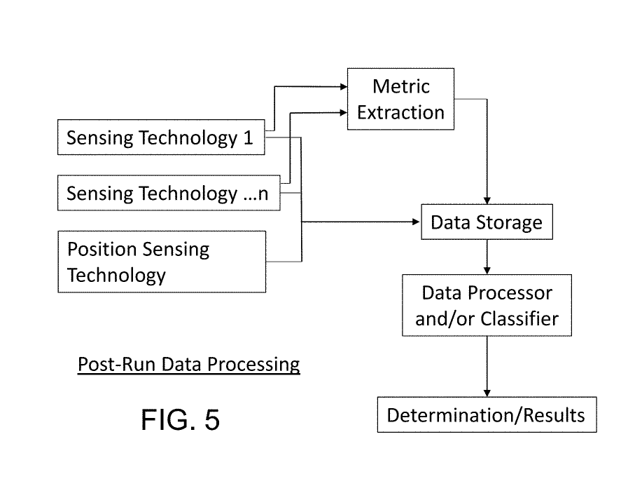

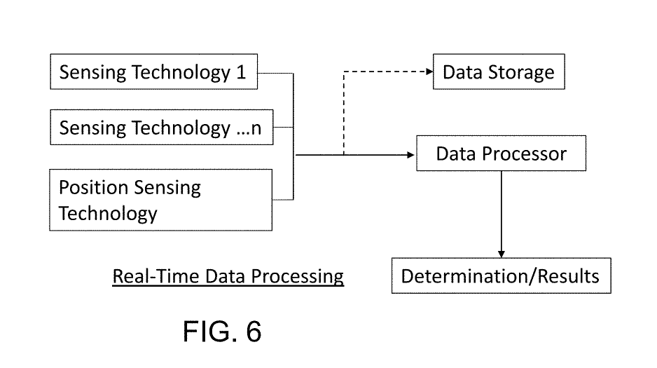

The data is collected and processed via a data processor, which may be part of the tool or may be remote from the tool (and may process data transmitted from the tool or collected by the tool and processed after the tool has completed its data collection). The processing steps are shown, for example, in FIGS. 5 and 6.

### VAM Apparatus/Systems/Configurations/Techniques

### Pump and Probe:

In accordance with an aspect of the present invention, a relatively low frequency emission (a pump) is applied to a specimen under test/evaluation/inspection. The pump may be applied locally or remotely. A second, higher frequency emission (a probe) is applied near an area to be inspected. The pump and probe emissions may be generated from a single broadband transducer source.

Cracks and similar discontinuities cause a nonlinear mixing of the frequencies emitted by the pump and probe. This nonlinear mixing of the frequencies does not occur with general wall thinning, pitting, etc. Thus, the resultant unique frequencies can be analyzed to assess crack position and size.

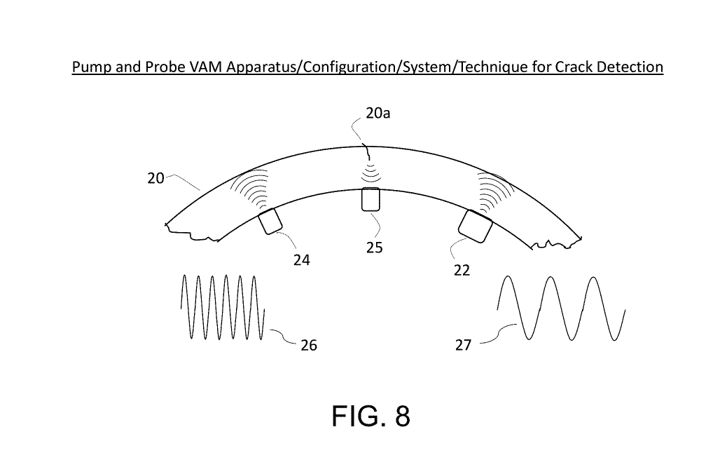

Use of such a pump and probe configuration or system (see FIG. 8) allows for simpler sensors with no intricate timing (e.g., phased arrays) required. The detection is performed at frequencies very different from the pump and probe frequency, eliminating most self-interference from the transmitter and increasing probability of detection. Very little, other than cracks, will cause the frequency mixing, greatly increasing probability of identification and substantially reducing the possibility of a false positive. Such a configuration or system is omnidirectional—i.e., the crack orientation should have little effect on the measurement. This method yields far richer responses than traditional amplitude methods, which include resonance and anti-resonance methods.

As shown in FIG. 8, the material under test (such as a conduit or tubular or plate or beam) 20 may have a crack 20a. The sensing device includes a pump or low frequency transducer 22 and a probe or high frequency transducer 24, and a receiver or transducer 25. The probe transmits or emits a high frequency signal 26 and the pump transmits or emits a low frequency signal 27, which causes a response at the crack 20a, whereby the receiver 25 (disposed between the transducers) may detect the signal response and thus detects a presence of the crack.

The pump and probe system utilizes low frequency (LF) transmitter(s) (one or more pumps), high frequency (HF) transmitter(s) (one or more probes), and an array of acoustic emission (AE) sensor(s) (one or more receivers).

### Pump and Probe—Modulated Carrier Method (Single Transducer Pump and Probe):

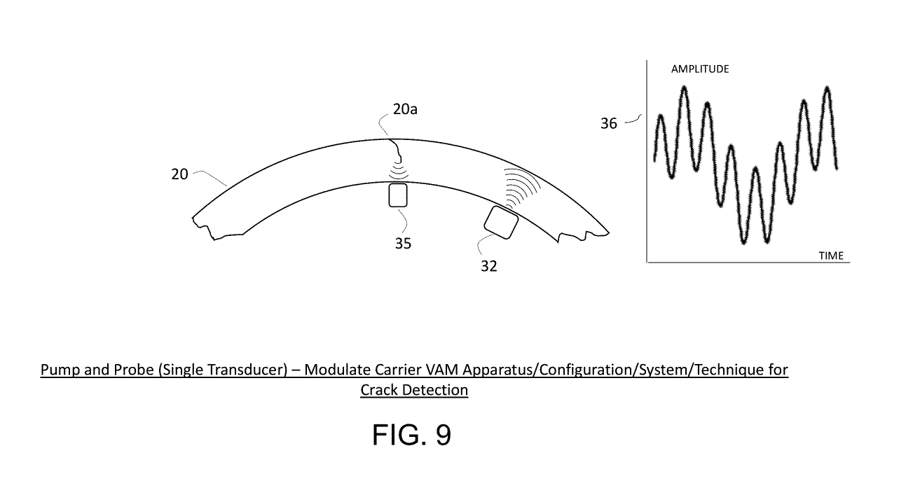

This approach (see FIG. 9) is a similar or same concept as the pump and probe method, discussed above, but with the following modifications:
A single transmitter (transducer) 32 serves as both the pump and probe.
The transmitter has sufficiently wide bandwidth to serve both functions.
The two frequencies would be linearly mixed electronically, applying the signal to the transducer.

Thus, and such as shown in FIG. 9, the single transmitter 32 transmits a signal 36, which causes a response at the crack 20a of the tubular 20, whereby the receiver 35 senses the crack.

Such an approach simplifies the overall pump and probe concept (size and complexity), and requires fewer transducers, drive amplifiers, etc.

This pump and probe system utilizes a wide bandwidth transducer, an array of acoustic emission sensors (receivers), and a diplexer or transmit/receive switch (for complete round-trip emission reception).

Passive Listening (Via High and/or Low Frequency Pump):

In accordance with another aspect of the present invention, an application of sufficient acoustic energy will cause physical displacement of the specimen material (where thickness<<length), propagating a Lamb wave. Absence of cracks or crack-like flaws, the Lamb wave propagates across the specimen. If/when the applied wave energy encounters a crack, the plate motion on one side of the crack is disparate from the other side of the crack. This will result in relative motion of the two walls of the crack—causing the crack to produce a recordable acoustic emission.

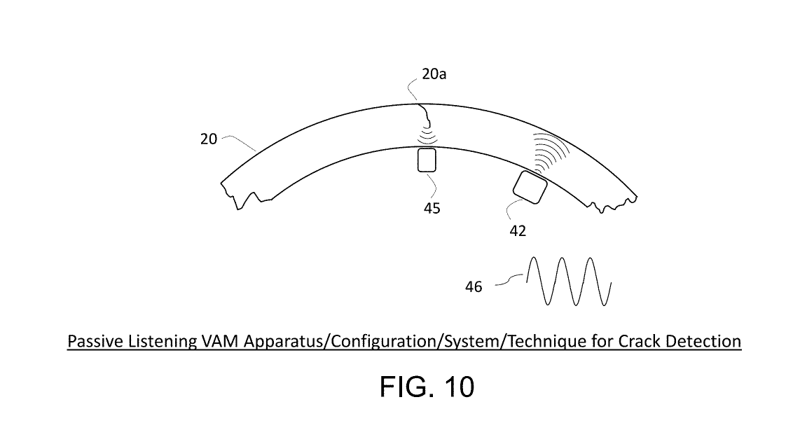

In the passive listening approach (see FIG. 10), the excitation source 42 generates antisymmetric Lamb waves 46 in the pipe wall 20, causing undulations in the surface. Homogeneous material will follow the pipe wall motion as a cohesive mass, but cracking 20a will cause some parts of the wall to move in a very different way than the material immediately adjacent to it (on the other side of the crack). This relative motion between the two walls of the crack generates squeaks, chirps, pops, etc., collectively known as “acoustic emissions”, which can be sensed by the receiver 45. It can be likened to walking through an old house, stepping on a board in one place and hearing a squeak emanating from somewhere else in the floor.

These acoustic emission (AE) signals will be present during the excitation period and for some period of time afterward. They will be much higher in frequency than the excitation frequency (frequencies). The very large difference in frequencies means that separation of the AE signal from the excitation is nearly trivial. There should also be very little else occurring at such high frequencies providing a relatively quiet listening environment.

The passive listening system requires only one source, which allows for further simplification in the transduction design, and can also be implemented using longitudinal compressional waves in place of Lamb (transverse) waves. The system provides enhanced sensing of cracks, as only cracks will produce acoustic emissions, and structures without cracks are not capable of generating such emissions.

The passive listening system comprises one or more transmitter transducers (global or large region pump and/or probe source) and an array of acoustic emission sensors as receivers (at least one or more acoustic emission sensors, and at least one or more arrays).

Tubular Wall Surface or Thickness Excitation (Max. Displacement of Mode I Crack Behavior):

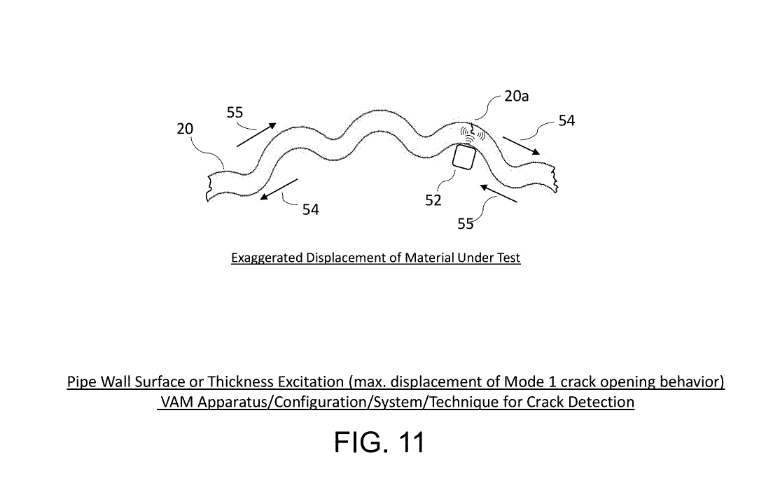

In accordance with another aspect of the present invention, a low frequency pump excitation, via, for example, an electro-magnetic acoustic transducer, may be applied orthogonally to the surface of the structure causing motion within the crack or flaw (see FIG. 11). As shown in FIG. 11, an electro-magnetic acoustic transducer 52 emits an acoustic wave 54 orthogonally to the surface of material under test 20 which causes a response at crack 20a. The acoustic wave 55 then returns and is sensed by the transducer 52.

The round trip time in the material under test has an associated frequency (f=v/2t), where f=frequency, v=material acoustic velocity, and t=material thickness. The aforementioned crack motion is a function of the pump excitation energy. The crack motion causes velocity changes in the round trip signal. The aforementioned velocity changes generate frequency sidebands on either side of the primary round trip frequency (this applies to longitudinal waves as well). Specific patterns in the frequency spectra have correlations to quantity of cracks (such as colonies) and size characteristics allowing for the determination of a damage severity index. These patterns are found through interrogation techniques such as, but not limited to, passive listening, phase inversion, stepped amplitude, pump frequency method, etc.

The low frequency pump excitation approach leverages the base information relating to an undamaged pipe and its associated round trip frequency. The round trip frequency acts as a “base reference” and variations on either side from the base reference round trip frequency represent crack presence and sizing information. Simple ratiometric analysis approaches can be used with great productivity to process associated signals.

Comparison (for damage severity indexing) of the base reference round trip frequency to the upper and lower sidebands can be performed ratiometrically to eliminate dependence on specific response amplitude variations.

The low frequency pump excitation comprises a single point sensor that is emitting and receiving. An additional apparatus could include tightly packed return signal receive sensors.

### Varied (Stepped, Ramped, etc.) Amplitude:

In accordance with another aspect of the present invention, an acoustic energy applied to the material under test will cause crack motion, such as opening and closing (Mode I crack behavior) or motion in in-plane sliding shear and out-of-plane scissoring shear (Mode II and Mode III crack behavior). These crack behavior motions create nonlinearities in the acoustic signal used to excite the cracks. Additionally, acoustic emissions are produced due to the motion of the cracks (that are excited).

With increased applied acoustic energy, the crack behavior will transition through different regimes of activity—each with unique characteristics. When amplitudes are stepped higher or lower via transduction of the emitted acoustic energy, the response spectra for each amplitude step establishes spectral response signals that change as a function of the amplitude. When the proper stepped range of excitation amplitude is produced then associated response signal spectra can produce multiple unique response regimes or classes.

When a non-linearity such as a crack exists, two or more of these regimes being present correlates with the presence of a crack. When a crack is present and being modulated by a progressively higher amplitude, then the resultant frequency response spectra will tend to go down in frequency as the amplitude increases. When a crack is not present these associated frequency regimes/frequency deviations do not occur.

The acoustic energy application method produces enhanced information related to crack depth as crack depth affects how and when crack motion changes modes. This simplicity allows for regime changes and/or frequency changes to be a simple method to detect crack presence. If there are no cracks present, amplitude driven regime changes are not possible since these regimes represent the specific pathology of the crack motion (Mode I, Mode II, and Mode III crack behavior).

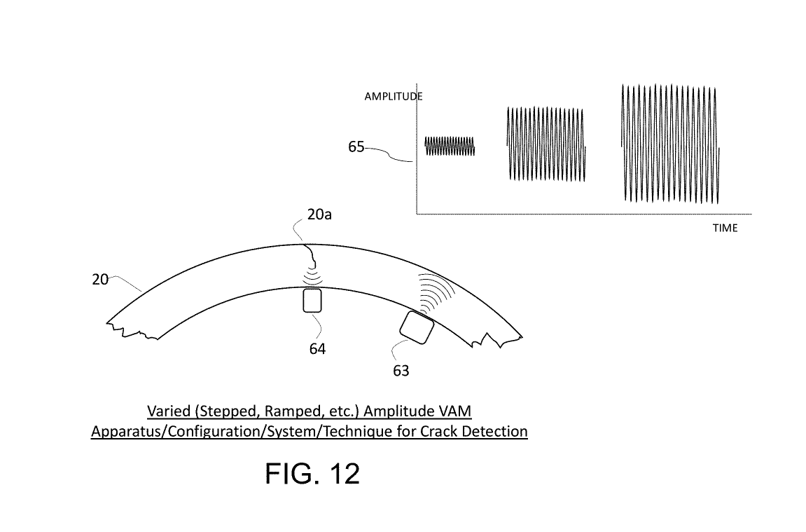

This system or configuration (see FIG. 12) comprises a transmitter capable of wider power range, array of one or more acoustic emission sensors as receivers. As shown in FIG. 12, a transmitter 63 transmits a varied or stepped signal 65 through the material under test 20, including crack 20a. The stepped signal 65 causes a response in or at the crack 20a, which is then sensed by the receiver 64.

It is assumed that the cracks are closed or nearly closed. A set of pulses, with each pulse differing in energy, for example amplitude, is emitted. The waveform contained in each pulse may be arbitrary. The difference between the pulses is in the total energy emitted per each pulse. It is expected that 3-4 (but possibly more) steps of varying energy are in the pulse train. It is readily apparent that with low excitation energy, small cracks and tightly closed cracks will behave mostly linearly, whereas larger cracks will exhibit non-linear behavior. Under higher excitation levels, the individual crack “faces” of these small or tightly closed features will be set into motion out-of-phase from each other, and will exhibit non-linear crack responses. Thus, the presence and severity of cracks can be assessed.

In addition, because larger, deeper cracks decrease the mechanical stiffness of the system, the frequencies returned from the pipe will decrease with increasing pulse amplitude.

### Phase Inversion:

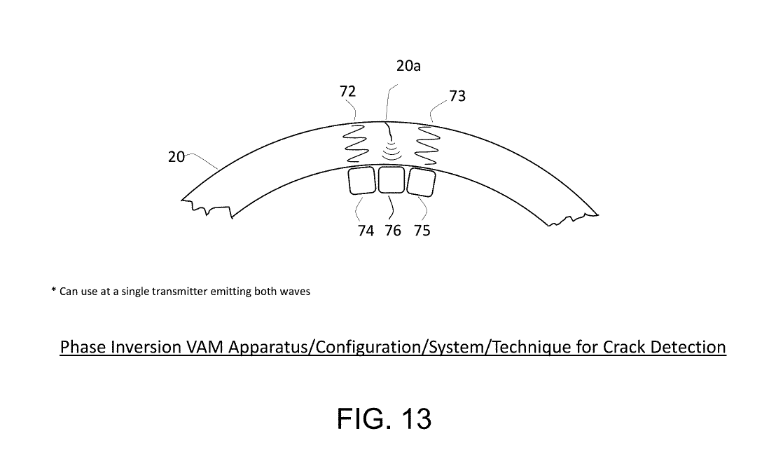

In accordance with another aspect of the present invention, a “Two Step Method” Phase Inversion (see FIG. 13) operates to detect cracks. Step one produces a half or full-wave excitation of one polarity and capturing and storing the return response of this step. Step two inverts the polarity of the first step excitation and then emits this signal as the second step excitation—the return responses of this step of excitation are also captured and stored.

As shown in FIG. 13, a transmitter 74 transmits a positive wave excitation 72 and another transmitter 75 transmits a negative wave excitation 73 through the tubular 20. The responses (such as at a crack 20a) are sensed by a receiver 76.

The two responses of step one and step two are summed. If the summation of the two step return signals produce a zero sum (or near zero sum), then it is determined that no crack is present. If the summation of the two phase response signals are non-zero, then it is determined that a crack is present.

The phase inversion system or method may comprise a “Balanced Method” Phase Inversion, where two transmitters are located proximate to each other and emit the same signal, but of opposite phase. This will destructively interfere and cancel each other out when the material under test is homogeneous (no cracks/defects)—resulting in little to no signal. With cracking present, the balance between the transmitters is upset and the waves do not cancel as effectively as when the material is without cracks/defects—thus, a signal is provided that indicates the presence of cracking.

This balanced method phase inversion approach provides a very simple system and method, with a low hardware burden and a low computational burden. This approach also integrates easily with other methods (e.g., enhanced with stepped amplitude method). This approach is multi-method capable and is compatible with other crack detection techniques.

This balanced method phase inversion approach comprises two matched transmitters (for the balanced method) or one transmitter (for the two-step method), and an array of acoustic emission sensors as receivers (e.g., for transducers/sensors: air coupled, contact, with acoustic cavity, etc.), signal sources and drive amplifiers, power supplies, and the like.

### Chaotic Cavity:

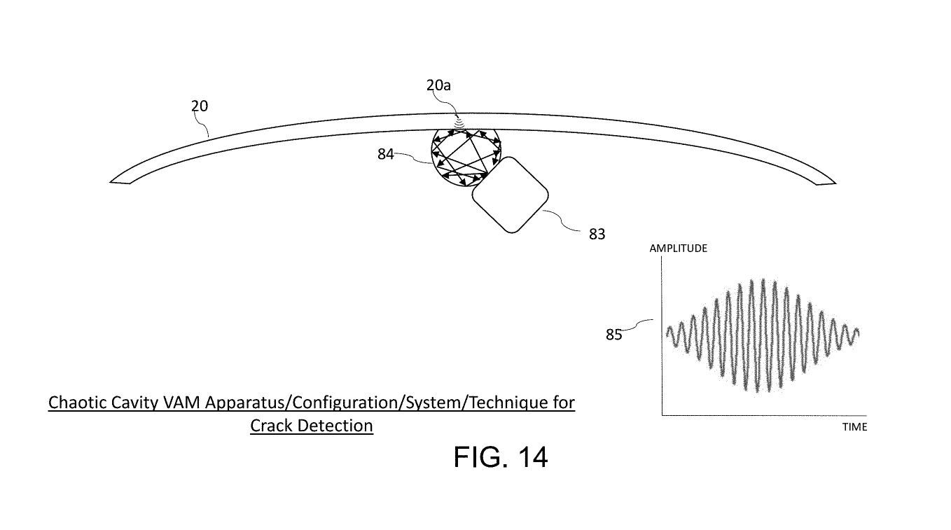

In accordance with another aspect of the present invention, a chaotic cavity crack detection system or configuration or approach (see FIG. 14) is operable to detect cracks. This approach is based on utilizing an ultrasonic/acoustic transducer/sensor 83 and using a chaotic cavity 84 comprising any number of various geometries that allow for a transmitted signal 85 to be reflected chaotically within the cavity, with intent to produce complex acoustic chaotic scattering when excited with either contact or air coupled transducer(s). The system senses the response at the surface of the material under test 20 to detect cracks 20a thereat. The chaotic cavity may comprise a hollow chamber or solid slab attached at the transducer/sensor.

The greater the complexity of the cavity, the richer the opportunity to focus energy and control the size of the energy emission focal spot size. This system thus produces a response with greater ‘localization’ of energy and consequently generates a healthier response signal. Cavities can take an infinite number of forms and produce significant benefits without exhaustive design optimization.

The various scattering points of the complex chaotic cavity are referred to as virtual emitting points or virtual sensor points. With the right management of excitation characteristics and other parameter choices, it is possible to use a single transducer to create novel capabilities, such as a virtual phased array. Virtual phased arrays use a chaotic cavity and one or more transducer/sensors to replicate or surpass the capabilities of phased arrays that use many more individual (real) sensors, and associated amplifiers and receivers to work with each real transducer/sensor.

The chaotic cavity method can be deployed with a single transducer, such as, for example, an ultrasonic transducer or the like, or multiple transducers, with the (necessary) capability to both emit and receive return signals. Associated with the use of chaotic cavities is a time reversal mirror method that allows for a two stage transmission and two stage reception process to enhance signal emission in terms of focus and intensity, as well as improving return signal to noise ratios.

The chaotic cavity approach provides greatly reduced complexity without incurring severe limitations of performance when compared to phased arrays. Such a device employs a greatly reduced level of electronics to implement as compared to a phased array. Compared to conventional phased arrays, this approach greatly reduces the complexity and number of transducers, excitation amplifiers, receiver channels, in some cases by over two orders of magnitude. The chaotic cavity approach yields similar or better performance (focal spot size, energy intensification, direction control) while shrinking overall package size, power consumption etc.

This chaotic cavity approach utilizes conventional air coupled or direct coupled transducer(s) and an associated cavity. Drive electronics, as well as receiver electronics may comprise conventional components.

### Impedance Methods:

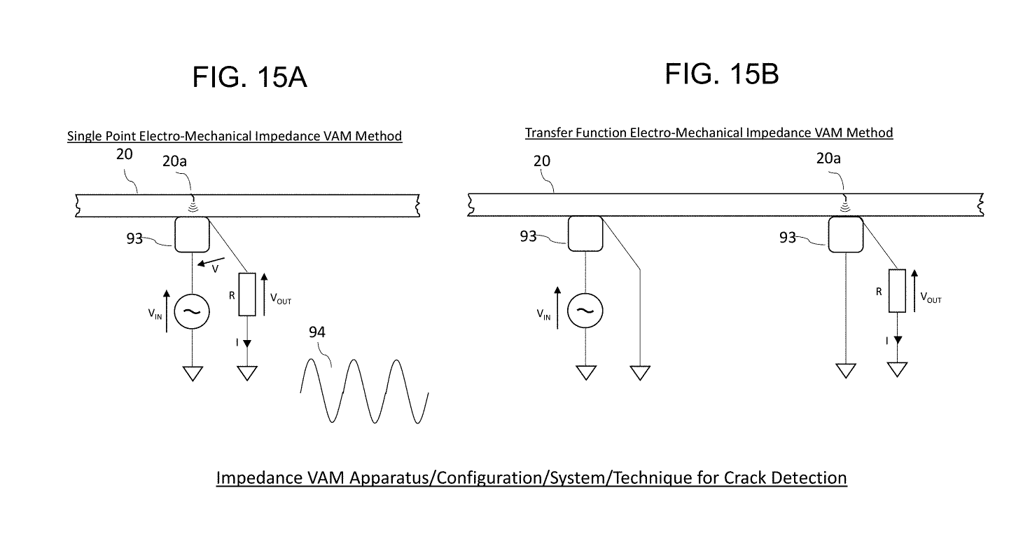

In accordance with another aspect of the present invention, an impedance method (see FIGS. 15A-15B) is used to detect cracks. This approach is based on the interaction between an exciter and specimen (such as a pipe or conduit). When an exciter is coupled to a physical specimen, there is an interaction between the two. This causes the exciter to react in a different manner than if it were in free space. As a result, differences can be observed in the drive circuitry attached to the transmitter and can be interpreted as a change in the material (e.g., cracks, defects, etc.).

As shown in FIGS. 15A and 15B, one or more transducers 93 transmits a signal 94 which causes a response in or at a crack 20a of the tubular 20, with the response being sensed by the drive circuitry attached to the transmitter(s) 93.

The Electro-Mechanical Impedance Method involves one or more transducer(s) (utilizing any given transducer, such as, for example, a piezoelectric transducer or the like, as an excitation source and return signal sensor) mechanically, electrically, or magnetically coupled with the surface of the “structure under test.” From an electrical equivalence perspective, the transducer/sensor device(s) is “well characterized” in terms of its equivalent electrical properties. A given well characterized transducer is then coupled to a target structure. The target structure's mechanical equivalent impedance characteristics are a function of the health or damaged “state” of the material being interrogated. Variations in the damage severity in the target structure under test are observed in the electrical impedance characteristics of the transmitter, which can then be detected and classified by way of a multitude of signal processing strategies. Variations of dynamical parameters of the structure, as a result of damage (cracks), influence the measured impedance plots within the transducer/sensor—this in turn can be used for damage assessment.

This method may comprise one or more piezoelectric transducers in a circuit with a resistor and an AC voltage supply, both of which are connected to ground. Alternatively, a second piezoelectric transducer(s) in a circuit with a resistor, where both the transducer and the resistor are connected to ground may be used to determine a transfer function.

This method can detect near side as well as far side cracks of the specimen under test (e.g., tubular wall, plate, etc.). While preferably implemented as a direct contact method, there are air coupled methods, such as eddy currents, that can be deployed as well.

With this impedance method/approach, no receivers are required. Thus, there is simplicity in the device design. These methods provide an ability to assess damage (cracks).

This method or configuration comprises a transmitter with detection circuitry for the drive. This method is unusual in that a separate receiver is not required. One implication of this fact is that the impedance method can be piggybacked on just about any other method discussed herein. For example, consider driving a transducer that is coupled with a specimen. For simplicity, a simple eddy current coil over a conductive specimen may be considered. The circuit driving the transducer sees a particular complex impedance load at its terminals. As long as the conditions remain very similar, the impedance of the transducer will also remain very similar. However, when an anomaly is introduced into the specimen, the impedance of the transducer changes due to its coupling with the specimen. This change can be detected and further analyzed.

### Hoop Stress Method:

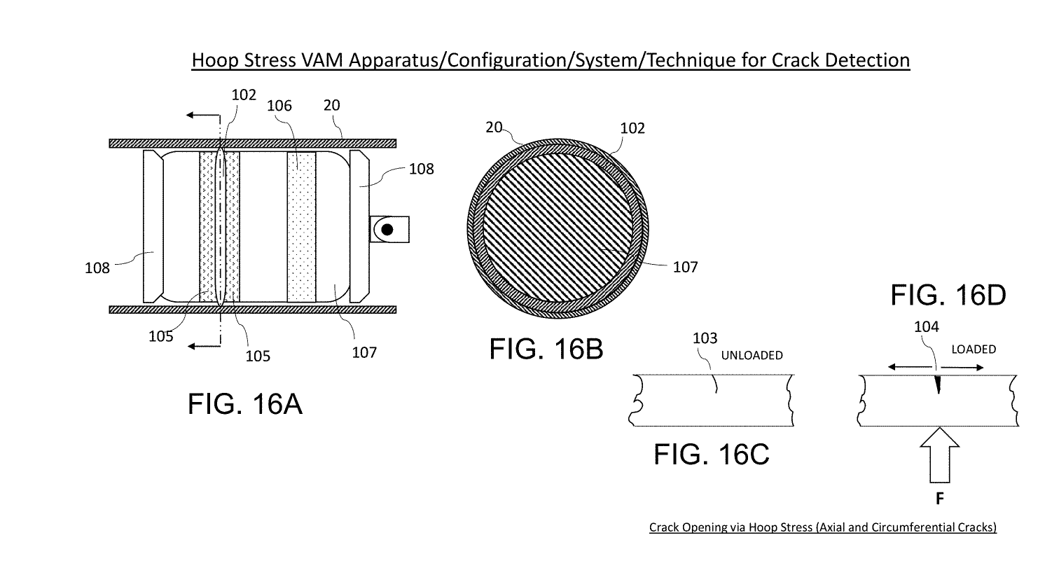

In accordance with another aspect of the present invention, a hoop stress method (see FIGS. 16A-16D) may be employed to detect cracks. A ring, typically comprised of a stiff, but flexible, material (metallic, non-metallic, or a combination such as a composite material), is positioned on a pipe inspection tool (commonly referred to as a “pig”) in such a way as to provide a large uniform outward pressure (this method works only on tubulars and does not apply to sheets or other forms). The ring thus expands the diameter of the tubular slightly in an area close to the ring. Pressure from the product in the tubular is used to propel the pig through the tubular and may also be employed to provide the deforming force.

Two or more transmitter-receiver sets are used to interrogate the pipe. One set is located so that it inspects the undeformed area and a second set inspects the area near the deforming ring. Cracks that are roughly aligned with the axis of the pipe will be opened slightly by the expansion created by the deforming ring. As a result, response from cracked samples will exhibit a difference in response between the two measurements while uncracked specimens will show little or no difference.

As shown in FIGS. 16A-16D, a hoop stress ring 102 of a module 107 is positioned around the tubular 20 and exerts pressure on the tubular. Such pressure alters an unloaded crack 103 (no hoop stress) into a loaded crack 104 (hoop stress applied). The sensor regions 105 and 106 detect the alteration of the crack 104. The module 107 may be equipped with one or more drive cups and/or cleaning rings 108.

An advantage with this approach is that it is not necessary to know anything about the uncracked response. The physical deformation will almost certainly open cracks that are closed, causing their response to change substantially. This approach requires no power source (such as a battery), and is purely driven by the motion of the tool. This approach may be utilized in conjunction with any of the methods described herein and may be used specifically for load application or incorporated into a drive cup or cleaning ring commonly used in pipeline tools.

This approach or configuration comprises at least two transmitter/receiver sets, and a deforming hoop stress ring.

### Vibrothermography (Non-Typical Pig Tool):

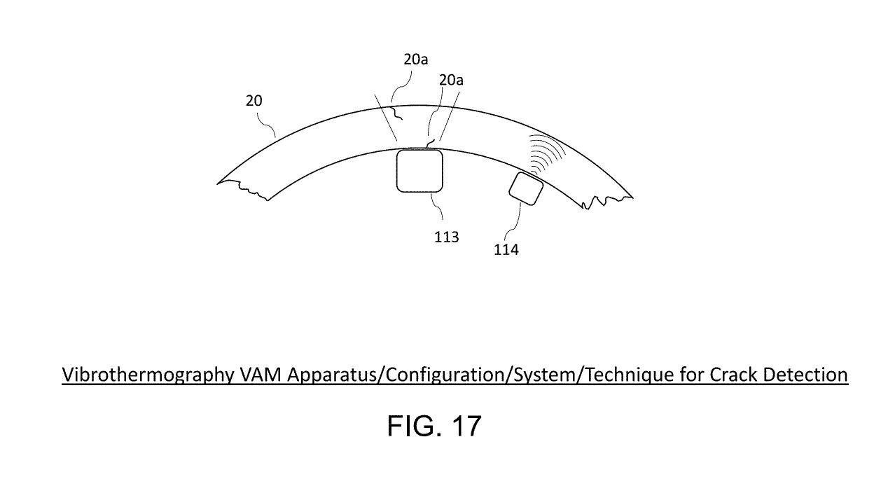

In accordance with another aspect of the present invention, a vibrothermography method (see FIG. 17) may be employed to detect cracks. Acoustic energy applied by an acoustic energy apparatus (e.g., a transmitter or the like) 114 to a specimen will cause localized movement of crack faces 20a of the tubular 20, which generates heat. Heat, in conduction, is transmitted at the speed of sound by phonons and can be observed at the surface of the specimen. This can be done tomographically to create a thermal image of a crack in the specimen (such as via a thermal imaging apparatus 113).

Such a vibrothermography method or approach provides a direct imaging method. The vibrothermography method or approach comprises a transmitter for generating acoustic energy, and a thermal imaging apparatus (e.g., FLIR imager, etc.). The transmitter may comprise any suitable transmitter for generating acoustic energy, such as, for example, transducers, trip-hammers, contact wheels with impact inducing geometry, acoustic focusing devices, and/or impact devices of various geometry providing random impacts.

### Detection Methods

The following discusses in detail the various detection methods used in conjunction with the techniques described above (see FIG. 4) to determine the location and characterization of cracks and crack-like features.

Passive Listening (Via High and/or Low Frequency Pump)

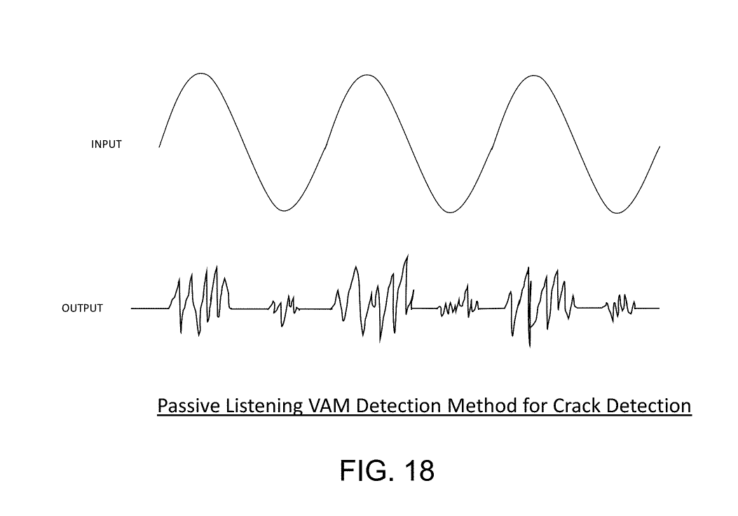

As discussed above, the passive listening method (see FIG. 18) typically uses an excitation source that generates antisymmetric Lamb waves in the pipe wall, causing undulations in the surface. A tool is conveyed into the tubular (pipeline, downhole, piping, etc.) or external to the tubular, if properly configured. The acoustic energy generating devices(s) is employed through electrical, magnetic, and/or mechanical means. As acoustic energy is emitted, homogeneous material will follow the pipe wall motion as a cohesive mass and Lamb waves will propagate across the specimen, but cracks present in the wall of the tubular will cause some parts of the wall to move in a very different way than the material immediately adjacent to it (on the other side of the crack). This relative motion between the two walls of the crack generates squeaks, chirps, pops, etc., collectively known as “acoustic emissions”.

These acoustic emission (AE) signals will be present during the excitation period and for some period of time afterward. They will be much higher in frequency than the excitation frequency (frequencies). The very large difference in frequencies means that separation of the AE signal from the excitation is nearly trivial. There should also be very little else occurring at such high frequencies providing a relatively quiet listening environment. A more detailed discussion of the passive listening methodology is included above, such that it need not be repeated herein.

### Intermodulation:

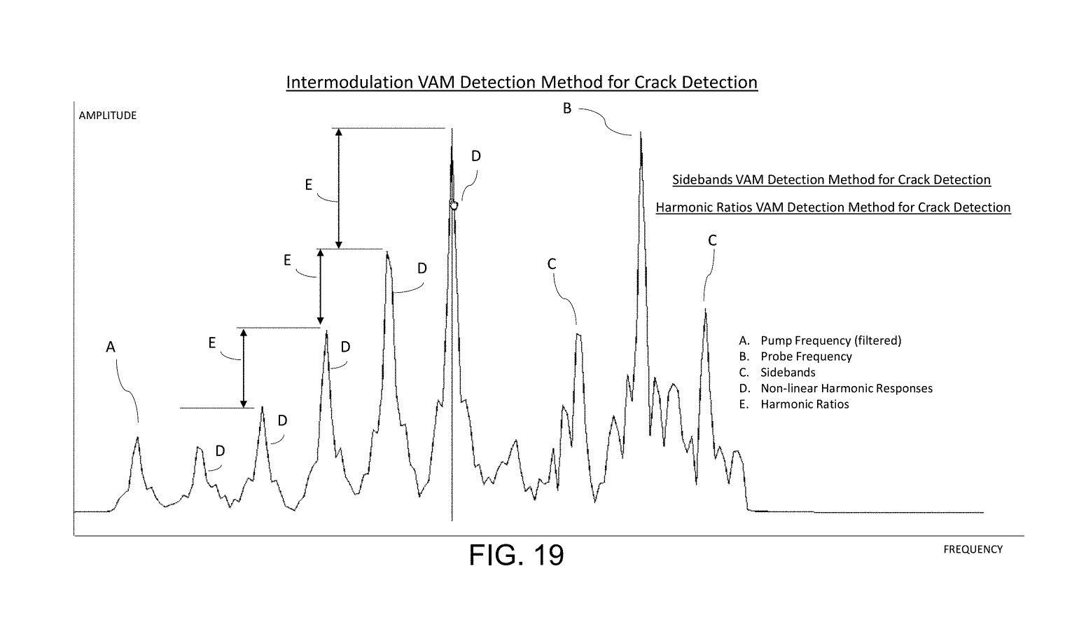

The intermodulation detection method (see FIG. 19) employs a pump transducer and a probe transducer operating at different frequencies, or else a single wide band transducer capable of emitting both frequencies at the same time. When cracking is observed in this case, it should appear as (1) the sum and difference frequencies of the two inputs, (2) a family of harmonics and sub-harmonics, and (3) sidebands adjacent to the sum and difference frequencies. Again, the response may be detected during excitation and for a short period afterward at frequencies that are very predictable and distinguishable from the excitation frequencies, allowing fairly easy isolation of the response signal. Harmonics, anti-resonances and ratios of harmonic amplitudes, as well as analysis of the sidebands, can be related to the morphology of the cracks.

Sidebands (Characterization—Indexing):

It is known within the signal processing field that when signals of different frequencies are combined in a linear manner, the result is simply those two frequencies. However, when those two frequencies are applied to a non-linear system with sufficient amplitude, then the result is the two frequencies (as in the linear case), the sum and difference of those two frequencies, and a series of harmonics lower and higher than the two base frequencies. In addition, as the motion of the crack responds to the excitation energy, it will modulate the frequencies resulting in sidebands adjacent to the primary frequencies. The physical size of the crack will control the intermodulation of the frequencies and the resulting sidebands. Thus, the resulting sideband characteristics lend to determining the morphology of detected cracks.

Harmonic Ratios (Characterization—Indexing)

As with the aforementioned Sideband method, when two frequencies are applied to a non-linear system with sufficient amplitude, then the result is the two frequencies (as in the linear case), the sum and difference of those two frequencies, and a series of harmonics lower and higher than the two base frequencies. The physical size of the crack will dictate the relative amplitude of the harmonics. Comparing the ratios of the harmonics to the primary frequencies and/or themselves provides the information to ascertain the morphology of detected cracks that are encountered. The ratiometric approach mitigates differences in, for example, transducer coupling which may occur from sample to sample.

### Frequency Shift as a Function of Amplitude:

A stepped amplitude excitation method cause cracks to be “set in motion”. This motion causes resultant ultrasonic signals to change velocity—which causes a change in related frequencies. Crack-related frequency responses appear as spectral sideband signals above and/or below carrier frequencies (as one example) if a defect is present—with only the central carrier frequency present if there are no cracks/defects existing. Specific synchronization of response signals with the specific variation of the pump/probe signals and their related amplitude will cause specific return signal responses to follow a pattern of producing lower frequencies at higher excitation amplitudes and low related frequencies with reduced amplitude.

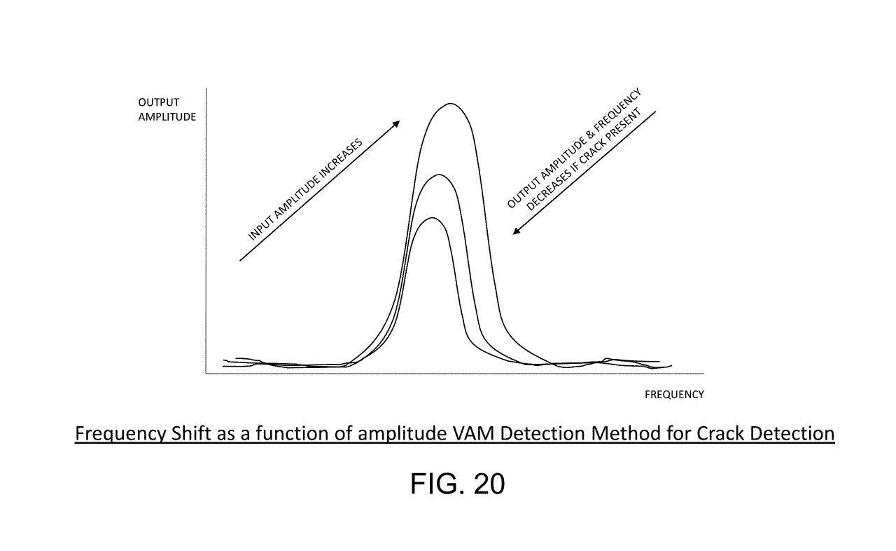

This frequency shift as a function of amplitude detection system (see FIG. 20) provides a simple approach that yields resultant response signal frequency change only if a crack is present. Incorporation of this technique in combination with other simultaneous methods is possible while still keeping overall complexity low (multi-method approach).

This approach or system comprises ultrasonic transducer(s) in the form of contact, air coupled, acoustic cavity with transducers, mechanical and associated signal sources and drive amplifiers, power supplies etc.

### Anti-Resonance Method:

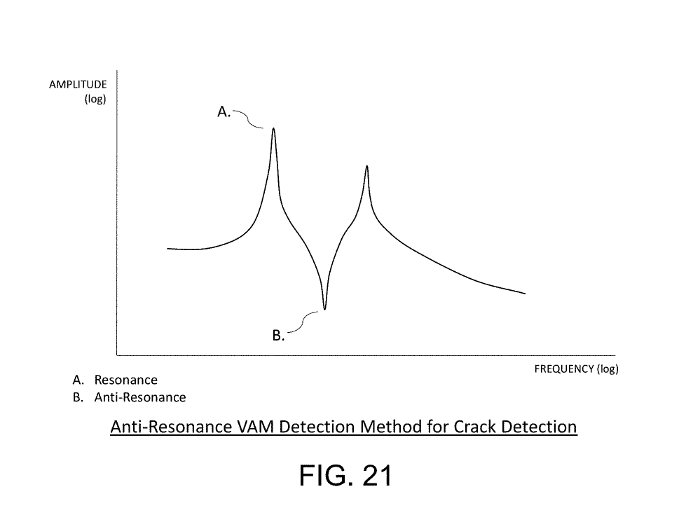

In accordance with another aspect of the present invention, an anti-resonance method (see FIG. 21) may be used to detect cracks. This method capitalizes on the fact that anti-resonance responds to vibration excitation locally. This method involves the capture of response signals harvested from ultrasonic transducers that are in close proximity to a given crack—these response signals result from local stiffness or damping variation which are representative of damage in structures.

This method utilizes a low frequency pump excitation while interrogating with either passive listening or one or more probe excitation/response transducers. The pump source can be from any origin that stimulates the system with sufficient energy to stimulate crack movement. In particular the method(s) for signal processing anti-resonant signals does not rely simply on Fourier Transform methods, but rather leverages strategic wavelet based signal processing to determine anti-resonance responses. Wavelet method or other frequency analysis strategies allow for rapidly selecting applicable bands of “subtle” anti-resonance responses.

Since local stiffness or damping variation occur when damage is present in structures, it is useful to detect the local variation as a means of structural damage inspection, as such local stiffness indicates a crack or defect at the structure. Anti-resonance responses may be determined using the transmissibility function or method. A transmissibility function represents the relation in the frequency domain of the measured response of two (or more) points in the structure. Measurement or apriori knowledge of excitation forces in a given system are not required for transmissibly methods to be deployed to derive reliable anti-resonance responses related to crack defects. Thus, the location and severity of the crack or defect can be determined from regions without flaws.

The anti-resonance method provides enhanced detection of defects at least in part because anti-resonance signals are more easily correlated to defect patterns. Associated methods employed with anti-resonance allow for using outputs from two or more response sensors without having any foreknowledge of specific system excitation to reconstruct a systems transfer function, as well as the actual characteristics of the excitation source. Therefore this method can be said to have commonality with other methods such as “passive listening” methods. When analyzing with multiple wavelet or other signal processes, anti-resonance frequency bands can be used to corroborate defect presence—a technique of redundancy. Passive listening for responses with no foreknowledge of the excitation source parameters.

The anti-resonance method allows for a wide variety of methods to be used, with no special hardware required—this is a post-processing methodology. This method leverages wavelet processing methods (or other functionally related methods of signal processing).

### Coda Waves:

As an acoustic pulse is applied to a specimen, a tail of the pulse dies back to zero. The tail of the pulse contains responses that are very characteristic for a specific medium (the medium of the specimen being inspected). The aforementioned portion of the characteristic response is called the coda. Any changes to the medium will manifest as changes to the character of the coda wave. Cracking/defects present in the specimen or structure produce observable differences in the coda waves.

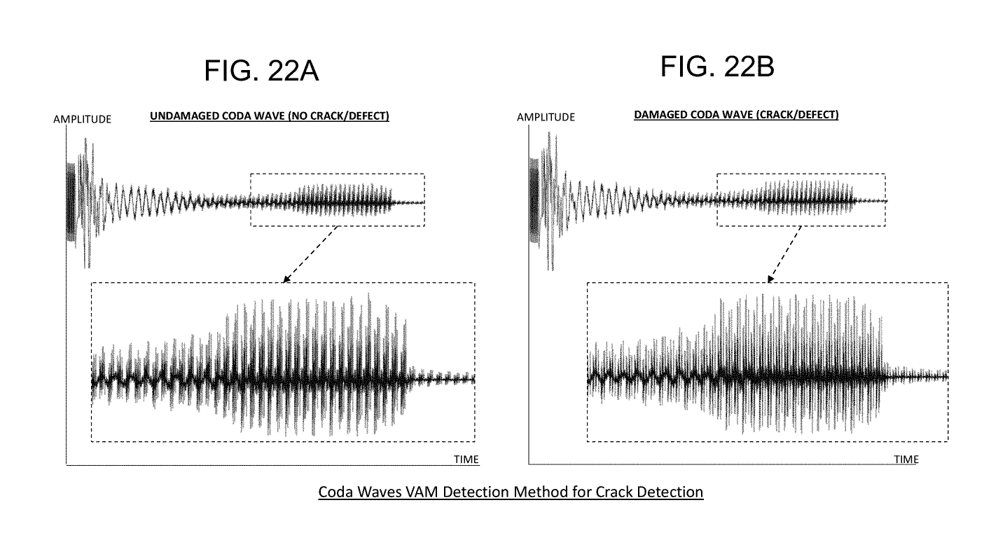

Coda waves (see FIGS. 22A-22B) address the ring-down portion of the output signals. A structure without cracks will produce a coda wave with a very distinctive pattern, even though the pattern may be very complex. If differences appear, particularly in phase, it can be taken as an indication of an anomaly. The system learns what is “good” or undamaged by looking at the ring-down signal from the various sensors deployed around the circumference of the tool. Additionally, as the tool moves along the pipe, more samples of undamaged pipe are obtained. Since any given tubular or structure will be mostly undamaged, even if it contains cracking, the system can learn the “good” or undamaged response quickly and then continually adjust on the fly.

This method is based on the nonlinear acoustic mixing of coda waves. Coda waves can originate from multiple signals scattering as a result from excitation sources (either sources of short duration or generated continuously over a given period of interrogation) with lower frequency-swept pump waves or low frequency broadband emissions in a pulse form. Nonlinear mixing is made possible by the presence of cracks and other defects (this does not occur in defect free structures under test).

With this method, it is unnecessary to know the material's transfer function. Instead, it is only required to know what the homogeneous coda response (e.g., when there are no cracks of defects present in the specimen or structure) looks like. Coda waves can be interrogated at key time windows for characteristic shifts in phase relating to crack presence—which is computationally low demand. Multiple windows of time can be interrogated and checked for consistency, working as an approach for multiple cross-correlation opportunities. Subtle period changes in coda wave responses can be interrogated for related velocity change details related to crack responses.

Coda wave methods integrate well with other methods such as ring-down/attenuation methods without any great additional computational burden for processing. Various pump/probe combination strategies allow for enhancement of coda wave response. Coda wave patterns tend to be even more predictable in terms of ‘well defined’ responses in metal materials if the higher data sampling rates are accounted for due to the high velocities of waves encountered in metal applications.

The coda wave method comprises a transmitter and one or more acoustic emission sensors, such as an array of acoustic emission sensors.

### Ring-Down/Attenuation Method:

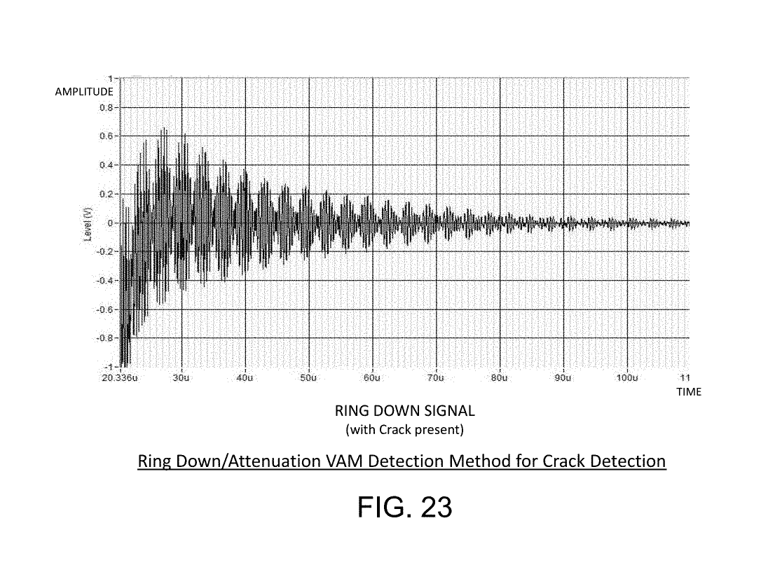

This method (see FIG. 23) utilizes the measurement response signal amplitude pattern decline of reflected signals in the time domain (over a given period of time). The response is from a given excitation transducer(s) emission. The response signal amplitude declines in the time domain more rapidly when a crack is present (when compared to material without crack(s) present). Time windows can be strategically selected to optimize the critical “time for response” versus “accuracy of response” tradeoffs necessary for a given application.

This method can be used with coda wave techniques with little added complexity. The method may be enhanced/extended using various pump and probe strategies. The pump and probe strategies can involve further enhancement by way of using multiple probes. An example of a pump and multiple-probe strategy may include a normal-oriented probe acting in concert with a wedge-angled probe—both operating at high frequencies (in the MHz range)—along with a low frequency pump.

When the emission or signal from the pump/probe terminates, the response seen in the pipe dies down in an exponential ring-down. Because cracks absorb significant energy, the ring-down in cracked intervals is expected to be shorter in time and is expected to have a different curvature (and other characteristics) from non-cracked intervals.

Due to its simplicity and ability to be customized, there are many variations of this approach or method that can be implemented with low computational burden. Even in a real time constrained applications, variations of the attenuation/ring-down methods could be used for “cross checking” validation purposes. Enhancement options such as the pump and multiple-probe strategy can improve amplitude signal-to-noise ratios providing improved crack detectability.

This approach or method comprises standard excitation and sensing schemes, with contact and non-contact sensing arrangements, and conventional ultrasonic sensors or other sensing methods (e.g., split ring resonators, etc.).

### Q—Cues/Factors:

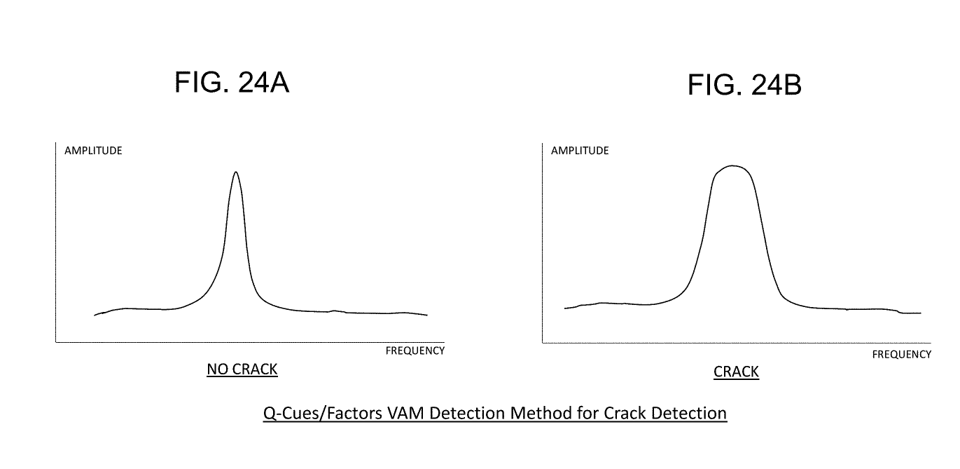

This method (see FIGS. 24A-24B) comprises a method by which the “Quality Factor” (also known as the Q Factor) of key emission frequency signal responses from the structure under test (and their related harmonic/subharmonic and non-harmonic/non-subharmonic responses) are examined for changes in quality factor. The Q Factor in this context can be defined as a given center frequency divided by the frequency width at some “decibel down point” (for example, the span 6 dB down from center frequency from the lower sideband to the upper sideband frequency—F_{c}/F_{usb}−F_{lsb} at −6 dB or whatever decibel down point level is chosen). The specific frequencies examined are adapted based on excitation methods and the respective key frequencies that are produced (single frequency excitation vs dual frequency excitation, as one example). When a crack is present at the structure or tubular, the “sharpness” of the response is decreased, and thus, the magnitude of the Q Factor decreases.

This approach or method provides a low computational burden, and is not dependent on specific amplitudes (ratiometric). This method can be used to cross check other crack detection methods using standard excitation methods and return signal response methods.

### Phase Inversion:

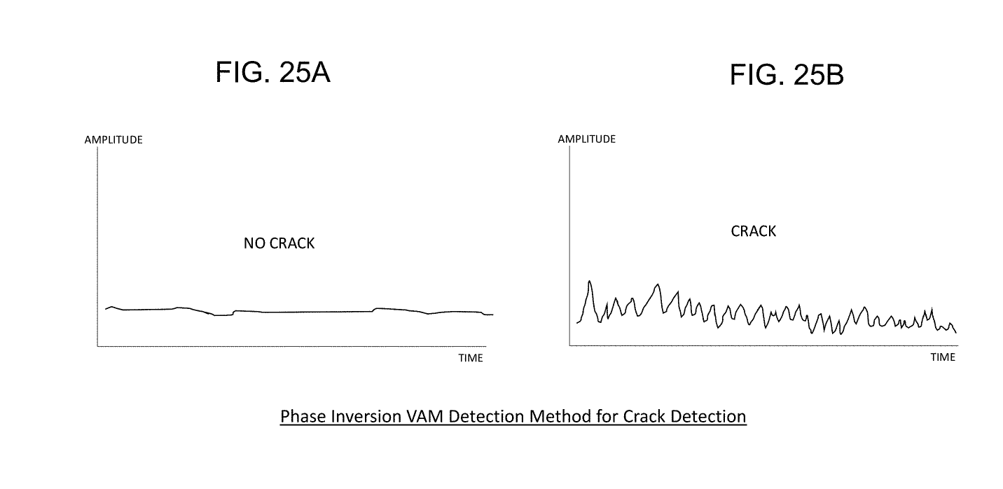

The phase Inversion method (see FIGS. 25A-25B) is based on the idea that if two closely-spaced transducers are fired with the same signal, but with opposite phase (see FIG. 13), then homogeneous materials, which have mostly a linear response, will sum the two outputs resulting in a near-zero response. Cracked intervals, though, will not produce the same linear mixing and will show marked anomalies. The phase inversion approach is discussed in greater detail above and need not be repeated herein.

### Vibrothermography (Non-Typical Pig Tool):

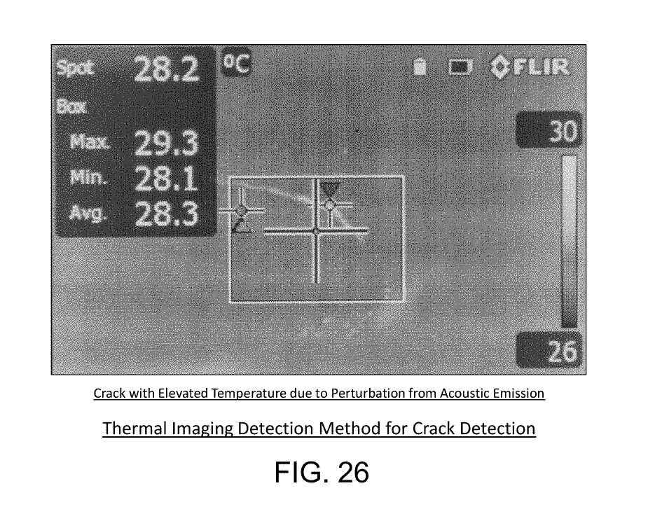

As discussed above, a vibrothermography method (see thermal image of FIG. 26) may be employed to detect cracks. Acoustic energy applied to a specimen will cause localized movement of crack faces, which generates heat. Heat, in conduction, is transmitted at the speed of sound by phonons and can be observed at the surface of the specimen. This can be done tomographically to create a thermal image of a crack in the specimen. Thermal imaging and/or sensing measurements are made around the circumference/inner wall of the inner bore of the tubular at desired axial increments (sample rate), further correlated with a position indicating means. Because the vibrothermography method is discussed above, a detailed discussion of this method need not be repeated herein.

### SUMMARY

Therefore, the present invention provides a tool that can be operated in pipelines (e.g., inline inspection of gas or liquid pipelines), downhole applications, other tubulars and structures of various geometry, for the purpose of crack detection. The tool utilizes means for positional and/or spatial relationship via items such as a caliper, encoder, gyroscopic devices, inertial measurement unit (IMU), etc. The tool may also utilize a caliper module for determination of geometry flaws, dents, etc.

The tool utilizes at least one, or any combination of sensing configurations and technologies (such as any of the VAM methods, systems, configurations and/or techniques discussed above). The tool may utilize individual sensor(s) or array(s) (comprised of one or more sensors) unlimitedly disposed in uniform or non-uniform arrangements/patterns for the sensing technologies and/or methods. The tool may utilize an electro-magnetic acoustic transducer to impart acoustic energy into the material under test in the various VAM methods, systems, configurations and/or techniques discussed herein.

For example, and such as shown in FIG. 4, the tool may include one or more systems or configurations for generating signals and determining cracks via one or more different respective or associated detection methods. For example, a pump and probe system or apparatus may detect cracks using one or more detection methods (discussed above) selected from the group consisting of intermodulation, frequency shift as a function of amplitude, anti-resonance, coda waves, ring-down, Q-cues/factors, and thermal imaging.

The tool may store data on-board, or may transmit data to a remote location for storage (and/or processing), or a combination of both. The tool may employ advanced data processing techniques to isolate and extract useful data as required. The tool may employ advanced data processing techniques that uses a single sensing technology and/or method, or any combination of sensing technologies (together or individually) and/or methods. Data processing may be conducted in real-time during tool operation, off-loaded externally to be conducted after completion of a tool operation, or a combination of both.

The tool may comprise at least one module. The module may contain at least one VAM methods, systems, configurations and/or techniques discussed herein. The module may contain multiple VAM methods, systems, configurations and/or techniques that may or may not interact with each other, and/or utilize shared componentry.

The tool may comprise multiple modules that may contain multiple VAM methods, systems, configurations and/or techniques that interact with each other, and/or utilize shared componentry. The tool may comprise multiple modules that may contain a single VAM method, system, configuration and/or technique that interacts between the multiple modules. The tool may comprise multiple modules that may contain multiple VAM methods, systems, configurations and/or techniques that interact between the multiple modules.

The tool may be self-propelled (such as, but not limited to a robotic crawler), or may be propelled by a gaseous or liquid medium pressure differential, or may be propelled via a cable in tension (pulled), or may be propelled via a coiled tube in compression (pushed), or a combination of any such propulsion techniques. The tool may be powered on-board, remotely, or a combination of both.

The tool may have a system and method to clean surfaces for better sensing abilities, incorporated with at least one module if utilized in the tool. The tool may be operated in tubulars with a wide variety of diameters or cross-sectional areas. The tool may be attached to other tools (e.g., material identification, magnetic flux leakage, calipers, etc.). The tool may simultaneously use the aforementioned sensing technologies with existing tools' sensing capabilities and/or system(s)—(e.g., crack detection system(s) utilize other tool capabilities simultaneously through shared componentry, magnetic fields, perturbation energy, waves, etc.).

The tool may include the means to determine position/location/distance such as, but not limited to, global positioning system(s), gyroscopic systems, encoders or odometers, inertial measurement units, accelerometers, and/or the like. The tool may include the means to determine position/location/distance that stores this data on-board or transmits it to a remote location, or a combination of both. The tool may combine the position, location, distance data simultaneously with sensing data collection at any discrete location within the tubular, or on a structure's surface.

An additional version of the tool may be mounted externally to a tubular via fixture, frame, cabling, etc. to detect cracks on the exterior surface(s) of the tubular. The additional version of the tool may have a sensing “suite” that is moved manually, is powered, or is pre-programmed to operate in a pattern.

The tool may utilize a transduction method such as time reversal techniques (via processing code) applied to one or more VAM methods, apparatus, systems, configurations and/or techniques included herein as an enhancement.

The tool may utilize virtual phased arrays in the form of one or more virtual emitters and one or more virtual receivers. The tool may be configured to be conveyed within a borehole to evaluate a tubular within the borehole. The tool may further comprise a conveyance device configured to convey the tool into the borehole. The tool may be configured to be conveyed into and within the borehole via wireline, tubing (tubing conveyed), crawlers, robotic apparatuses, and other means.

Therefore, the present invention provides a tool or device that utilizes one or more sensing systems or devices or means to sense and collect data pertaining to cracks in the pipe or conduit or other structures in or on which the tool is disposed. The collected data is processed and analyzed to determine the cracks in the pipe or structure at various locations along the conduit or pipeline or structure.

Changes and modifications to the specifically described embodiments may be carried out without departing from the principles of the present invention, which is intended to be limited only by the scope of the appended claims as interpreted according to the principles of patent law including the doctrine of equivalents.

1. A crack detecting system operable to detect cracks along a conduit or structure, said crack detecting system comprising:
a tool movable along a conduit or structure and having at least one sensing device for sensing cracks in a wall of the conduit or structure;
a processor operable to process an output of said at least one sensing device;
wherein, responsive to processing of the output of said at least one sensing device by said processor, said processor is operable to determine a presence of cracks at the wall of the conduit or structure; and
wherein said at least one sensing device comprises a vibroacoustic modulation technique.

2. The crack detecting system of claim 1, wherein said tool comprises at least one module with each module having at least one sensing device.

3. The crack detecting system of claim 1, wherein said tool comprises at least two modules with each module having a respective sensing device.

4. The crack detecting system of claim 1, wherein said at least one sensing device comprises at least two sensing devices using different sensing technologies.

5. The crack detecting system of claim 1, wherein said at least one sensing device comprises a sensing device that senses acoustic waves at the wall of the conduit or structure.

6. The crack detecting system of claim 1, wherein said at least one sensing device comprises a sensing device that senses coda waves at the wall of the conduit or structure.

7. The crack detecting system of claim 1, wherein said processor, via processing of the output of said at least one sensing device, determines the cracks at an interior surface of the conduit or structure.

8. The crack detecting system of claim 1, wherein said processor, via processing of the output of said at least one sensing device, determines the cracks at an exterior surface of the conduit or structure.

9. The crack detecting system of claim 1, wherein said vibroacoustic modulation technique comprises at least one technique selected from the group consisting of (i) a passive listening method, (ii) a wall excitation method, (iii) an intermodulation detection method, (iv) a frequency shift detection method, (v) an anti-resonance method, (vi) a coda wave detection method, (vii) a Lamb wave detection method, (viii) a ring-down attenuation method, and (ix) a quality factor detection method.

10. The crack detecting system of claim 1, wherein said vibroacoustic modulation technique comprises a chaotic cavity technique.

11. The crack detecting system of claim 10, wherein the chaotic cavity technique comprises virtual phased arrays.

12. The crack detecting system of claim 10, wherein the chaotic cavity technique comprises a time reversal technique.

13. The crack detecting system of claim 1, wherein said vibroacoustic modulation technique comprises a varied amplitude technique.

14. The crack detecting system of claim 13, wherein the processor is operable to determine the presence of cracks at the wall of the conduit or structure using at least one of the following detection methods: (i) passive listening, (ii) intermodulation, (iii) frequency shift as a function of amplitude, (iv) anti-resonance, (v) coda waves, (vi) ring-down attenuation, (vii) Q-Cues/Factors, and (viii) thermal imaging.

15. The crack detecting system of claim 1, wherein the at least one vibroacoustic modulation technique comprises a phase inversion technique.

16. The crack detecting system of claim 15, wherein the processor is operable to determine the presence of cracks at the wall of the conduit or structure using at least one method selected from the group consisting of (i) passive listening and (ii) phase inversion.

17. The crack detecting system of claim 1, comprising a hoop stress technique, wherein the hoop stress technique alters a size of cracks in the wall of the conduit or structure, and wherein said at least one sensing device senses the cracks in a wall of the conduit or structure.

18. The crack detecting system of claim 17, wherein the processor is operable to determine the presence of the cracks at the wall of the conduit or structure using at least one method selected from the group consisting of: (i) passive listening, (ii) intermodulation, (iii) frequency shift as a function of amplitude, (iv) anti-resonance, (v) coda waves, (vi) ring-down attenuation, (vii) Q-Cues/Factors, (viii) phase inversion, and (ix) thermal imaging.

19. The crack detecting system of claim 17, wherein said vibroacoustic modulation technique comprises at least one technique selected from the group consisting of (i) a passive listening method, (ii) a wall excitation method, (iii) an intermodulation detection method, (iv) a frequency shift detection method, (v) an anti-resonance method, (vi) a coda wave detection method, (vii) a Lamb wave detection method, (viii) a ring-down attenuation method, (ix) a quality factor detection method, and (x) a pump and probe method.

20. The crack detecting system of claim 1, wherein said vibroacoustic modulation technique comprises a tubular wall surface excitation technique or a tubular wall thickness excitation technique.

21. The crack detecting system of claim 20, wherein the processor is operable to determine the presence of cracks at the wall of the conduit or structure using at least one method selected from the group consisting of: (i) intermodulation, (ii) frequency shift as a function of amplitude, (iii) anti-resonance, (iv) coda waves, (v) ring-down attenuation, (vi) Q-Cues/Factors, and (vii) thermal imaging.

22. The crack detecting system of claim 1, wherein said vibroacoustic modulation technique comprises an impedance technique.

23. The crack detecting system of claim 22, wherein the processor is operable to determine the presence of cracks at the wall of the conduit or structure using at least one method selected from the group consisting of: (i) frequency shift as a function of amplitude, (ii) anti-resonance, (iii) Q-Cues/Factors, (iv) phase inversion, and (v) thermal imaging.

24. The crack detecting system of claim 1, wherein said vibroacoustic modulation technique comprises a vibrothermography technique.

25. The crack detecting system of claim 24, wherein the processor is operable to determine the presence of cracks at the wall of the conduit or structure using a thermal imaging detection method.

26. The crack detecting system of claim 1, wherein the processor is located at a remote location from the tool.

27. The crack detecting system of claim 1, comprising storing data output from the at least one sensor in a data storage device of the tool.

28. The crack detecting system of claim 1, wherein the at least one sensing device comprises a plurality of transmitters and a plurality of receivers.

29. The crack detecting system of claim 1, wherein the at least one sensing device comprises an air coupled transducer.

30. The crack detecting system of claim 1, comprising a positional sensor operable to determine a position of the tool.

31. The crack detecting system of claim 1, wherein the vibroacoustic modulation technique comprises virtual phased arrays.

32. The crack detecting system of claim 1, wherein the vibroacoustic modulation technique comprises a time reversal technique.

33. A crack detecting system operable to detect cracks along a conduit or structure, said crack detecting system comprising:
a tool movable along a conduit or structure and having at least one sensing device for sensing cracks in a wall of the conduit or structure;
a processor operable to process an output of said at least one sensing device;
wherein, responsive to processing of the output of said at least one sensing device by said processor, said processor is operable to determine a presence of cracks at the wall of the conduit or structure; and
wherein said at least one sensing device comprises a pump and probe apparatus.

34. The crack detecting system of claim 33, wherein at least one sensor comprises a plurality of sensors, wherein the plurality of sensors comprises at least one transmitter and at least one receiver.

35. The crack detecting system of claim 33, wherein the at least one sensor comprises a single transducer operable as both a pump and a probe.

36. The crack detecting system of claim 34, wherein the processor is operable to determine the presence of cracks at the wall of the conduit or structure using at least one a detection method selected from the group consisting of: (i) intermodulation, (ii) frequency shift as a function of amplitude, (iii) anti-resonance, (iv) coda waves, (v) ring-down attenuation, (vi) Q-Cues/Factors, and (vii) thermal imaging.

37. A method for detecting cracks along a conduit or structure, the method comprising:
providing a tool comprising at least one sensing device for sensing cracks in a wall of the conduit or structure, wherein the at least one sensing device comprises a vibroacoustic modulation technique;
moving the tool along the conduit or structure and collecting data output from the at least one sensor;
processing the data output of the at least one sensing device; and
determining, based at least in part on the processing of the output, cracks at the wall of the conduit or structure.

38. The method of claim 37, wherein the at least one sensing device comprises at least two sensing devices using different sensing technologies.

39. The method of claim 37, wherein the at least one sensing device comprises a sensing device that senses Lamb waves at the wall of the conduit or structure.

40. The method of claim 37, wherein said at least one sensing device comprises a sensing device that senses coda waves at the wall of the conduit or structure.

41. The method of claim 37, wherein said at least one sensing device comprises two spaced apart transmitters that excite the wall of the conduit or structure via waves having opposite polarity, and wherein said at least one sensing device comprises a receiver that receives a response from the wall of the conduit or structure to determine a crack present at the wall between said transmitters.

42. The method of claim 37, wherein the tool comprises at least one positional sensor operable to determine a position of the tool and wherein the processing comprises processing the data output of the positional sensor.

43. The method of claim 37, wherein the vibroacoustic modulation technique comprises at least one technique selected from the group consisting of (i) a pump and probe method, (ii) a passive listening method, (iii) a wall excitation method, (iv) a varying amplitude detection method, (v) a phase inversion method, (vi) a chaotic cavity method, (vii) an impedance method, (viii) a hoop stress detection method, (ix) a vibrothermography detection method, (x) an intermodulation detection method, (xi) a frequency shift detection method, (xii) an anti-resonance method, (xiii) a coda wave detection method, (xiv) a Lamb wave detection method, (xv) a ring-down attenuation method, and (xvi) a quality factor detection method.
